(19) United States
(12) Patent Application Publication
(10) Pub. No.: US 2009/0019056 A1
(43) Pub. Date: Jan. 15, 2009

(54) Method, Sensor Network, and Sensor Node for Accessing Sensed Data

(75) Inventors: Nuru Yakub Othman, Montreal (CA); Roch Glitho, Saint-Laurent (CA); Ferhat Khendek, Montreal (CA)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/933,826

(22) Filed: Nov. 1, 2007

Related U.S. Application Data
(60) Provisional application No. 60/949,660, filed on Jul. 13, 2007.

(51) Int. Cl. G06F 17/30

(52) U.S. Cl. 707/10; 707/E17.032

(57) ABSTRACT

There is provided a sensor node, a network, and a method for accessing data from a sensor service. Sensor nodes comprise information related to sensor service(s) they provide and to services provided by other sensor nodes of the network, including description of external sensor services, the address of the sensor nodes providing the external sensor services, and identification of the service owner. When a sensor node receives a request for a sensor service from a requester, it determines that it does not support the sensor service, and further identifies another sensor node that supports the sensor service. Then, in a first variant, the sensor node returns to the requester the other sensor node's identification so that the requester can request the sensor service. In another variant, the sensor node requests from the other sensor node data related to the requested sensor service, and transmits it to the requester.

### RELATED APPLICATIONS

The present application is related to, and claims priority from, the U.S. Provisional Patent Application Ser. No. 60/949,660, entitled “A Web Services Based—Architecture for Accessing Data from Sinkless Wireless Sensor Networks”, filed on Jul. 13, 2007, the disclosure of which is incorporated here by reference.

### TECHNICAL FIELD

The present invention relates to the area of sensor nodes.

### BACKGROUND

A sensor may be seen as a type of transducer, which function is to sense a phenomenon and to translate that phenomenon into a signal that, most often, can be read or interpreted by a human. For example, direct-indicating sensors, such as for example a mercury thermometer, are human-readable. Other sensors must be paired with an indicator or display, for instance a thermocouple. Many sensors are electrical or electronic, although other types exist. Sensors are used in everyday life and their applications include automobiles, machines, aerospace, medicine, industry and robotics. Recently, technological progress allowed more and more sensors to be manufactured on the microscopic scale, as micro sensors, using various miniaturized technologies.

As sensors become more and more prevalent, so do their applications. For example, telecommunications service providers have seen a business opportunity in providing global access to sensor data for use by mobile subscribers. Thus, networks of sensors are now being implemented in various areas. Such networks can sense various phenomena (e.g. temperature, light noise, traffic, pollution, etc) and render the data available to users against cost.

One network architecture that is being used to implement sensor networks is the so called Wireless Sensor Network (WSN). A WSN is a wireless network consisting of spatially distributed autonomous devices using sensors to monitor various physical or environmental conditions at different locations. The development of wireless sensor networks was originally motivated by military applications such as battlefield surveillance. However, WSNs are now used in many civilian application areas including, among others, environment and habitat monitoring, healthcare applications, home automation, and traffic control.

In addition to one or more sensors, each node in a WSN is typically equipped with a radio transceiver or other wireless communications device, a small microcontroller or processor, and an energy source, usually a battery. Size and cost constraints on sensor nodes result in corresponding constraints on resources such as energy, memory, computational speed and bandwidth.

In the area of WSNs there are two possible network architectures. The first one is the sink-based architecture. A conventional sink-based WSN is generally made up of four entities: the sensors, the aggregators, the sinks, and the gateways, as shown in FIG. 1 (Prior Art), which illustrates a known WSN architecture. The sensors 100 are responsible of the actual sensing of the phenomena of interest, such as for example sensing the temperature over a given area. The aggregators 103 are logical representatives of the sub-area of interest; they summarize the sensed data for each sub-area by receiving it from one or more neighbouring sensors. The sinks 102 and 104 collect data from all the sensors 100 and aggregators 103, and interact with end-user applications 112 and 114 via a gateway, in order to render the sensed data accessible. The gateways 106 and 108 have a dual interface and act to bridge the WSN to the outside world. Applications 112 and 114 can access the sensed data from the WSN via the sinks 102 and 104, the gateways 106 and 108, and possibly via the internet 110, or other types of networks. Thus, the sink-less WSN architecture is characterised by the fact that sensed data from the WSN is collected by sinks 102-104 before being rendered accessible to end-user applications. While this modus operandi is the most common today, it also presents significant drawbacks, as the sinks can act as bottlenecks to the sensed data or render the sensed data purely inaccessible if one sink fails.

There are cases in which a sink-less approach is preferred. A sink-less WSN refers to a network of sensors that does not comprise a sink or a gateway. In such architecture, end-user applications interact directly with the individual sensors or aggregators. In general, the cases in which a sink-less WSN is preferred are when the individual sensors or aggregator nodes are sufficiently representative of an area of interest, when the application's devices are within or moving around the WSN, i.e. when applications need data from sensors in close proximity, or when the application needs extended access to data from a specific sensor. Examples of such applications scenarios are on-field data assessment, specialized indoor monitoring, certain rescue operations or other civil applications where the application user needs data which is in close proximity. In such circumstances, it is more beneficial if the end-user application devices can interact directly with the sensors in their neighbourhood then for the data to be sent to the sink or gateway and then back to the end-user application devices. This approach can save energy for the sensors as they don't need to implement long-range communications. The decentralization in sink-less WSN remove an undue burden from the sensors and aggregators that are close to the sink, as they would have had to handle significantly more communications in routing data to and from the sink, including data from and to other sensors. It is also unnecessary in the sink-less architecture for the sensors to run complex multi-hop algorithms. Communications can be as simple as a single hop from the sensors or aggregators to the application devices.

Although there is no solution as the one proposed by present invention, the publication “A Flexible Web Service based Architecture for Wireless Sensor Networks”, by Flávia Coimbra Delicato, Paulo F. Pires, Luci Pirmez, and Luiz Fernando Rust da Costa Carmo, from the Federal University of Rio de Janeiro, Brazil, published at the 23rd International Conference on Distributed Computing Systems Workshops, on May 19-22, 2003, in Providence, R.I., USA (Document # ICDCSW'03), bears some relation with the field of the present invention. This publication defines a WSN in terms of three roles and operations of web services. However, it still assumes the presence of a sink node, and requesting applications still bind to the sink nodes in order to obtain sensed data from a sensor.

Regarding the sink-less architecture, the publication entitled “TinyLIME: Bridging Mobile and Sensor Networks through Middleware”, by Carlo Curino et al, published at the Proceedings of the 3rd IEEE Int'l Conf. on Pervasive Computing and Communications (PerCom 2005), on Mar. 8-12, 2005, proposes an architecture that allows applications to discover and interact directly with relevant sensor nodes within a single hop distance from the application's devices. The interactions between application devices and sensor networks are achieved via a live application interface which requires understanding of the combined concepts from the mobile code, tuple, spaces, and events. Nevertheless, this publication stops short too of teaching the benefits of the present invention.

Reference is now made to FIG. 2 (prior art), which shows a typical sink-less architecture implementation know in the prior art. Shown in FIG. 2, is the sensor network 200 including sensor nodes 202, 204, 206, and 208. Each sensor node comprises a LIME stack 210, 211, 213, and 215, which function is to implement a notification broadcast mechanism for sending sensed data to peer sensor nodes. Sensor node 202 senses a phenomenon in action 212 (e.g. registering the surrounding temperature) and then uses its internal LIME stack 210 in order to broadcast 213 the sensed data descriptive of the sensed phenomenon to cooperating sensor nodes 204, 206 and 208. For that purpose, broadcast messages 214, 216 and 218 are transmitted, in order to inform the collaborating sensor nodes of the sensed data 219. However, it is apparent that in this sink-less architecture the cooperating sensor nodes meant to receive the sensed data have to be pre-defined in the sending sensor node. Therefore, this architecture does not allow flexible access to sensed data as it does not permit a requestor to solicit and obtain sensed data of interest without prior definition of the requestor in the sending sensor node.

Accordingly, it should be readily appreciated that in order to overcome the deficiencies and shortcomings of the existing solutions, it would be advantageous to have a solution for flexibly and efficiently exchanging sensed data between sensor nodes and application devices. The present invention provides such a method and sensor node.

### SUMMARY

In one aspect, the present invention is a method for handling a sensor service request received at a sensor node of a sensor network, the method starting with the sensor node receiving a request for a given sensor service from a requester. Then, the sensor node determines that it does not support the given sensor service, and further identifies another sensor node of the sensor network that supports the given sensor service.

In another aspect, the present invention is a sensor node comprising a description of a sensor service provided by the sensor node and a data storage module comprising information related to another sensor service provided by another sensor node, the information including a description of the other sensor service and an address of the other sensor node. The sensor node further includes a processing module that upon receipt at the sensor node of a request for the other sensor service from a requester, determines that the sensor node does not support the other sensor service and identifies the other sensor node that supports the other sensor service.

In yet another aspect, the present invention is a sensor network comprising a first and a second sensor nodes. Each one of the first and second sensor nodes comprises a description of a sensor service and an identification of an owner of the sensor service supported by that sensor node, and information related to another sensor service, the information comprising a description of the other sensor service supported by another sensor node, and an address of the other sensor node.

### DRAWINGS

For a more detailed understanding of the invention, for further objects and advantages thereof, reference can now be made to the following description, taken in conjunction with the accompanying drawings, in which:

FIG. 1 (Prior Art) is an high-level network diagram showing a sink-based architecture of a Wireless Sensor Network (WSN);

FIG. 2 (Prior Art) is an exemplary nodal operation and signal flow diagram of a known prior art implementation showing sensed data broadcast in a WSN;

FIG. 3 is a high-level node diagram of an exemplary sensor node according to the preferred embodiment of the present invention;

FIG. 4 is an exemplary nodal operation and signal flow diagram of the preferred embodiment of the present invention.

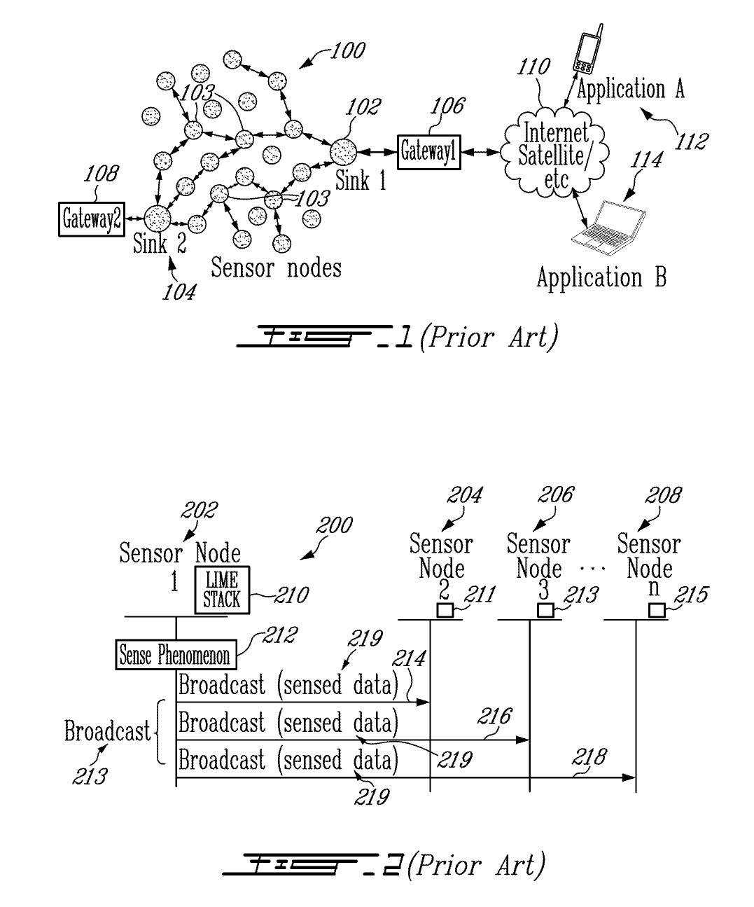

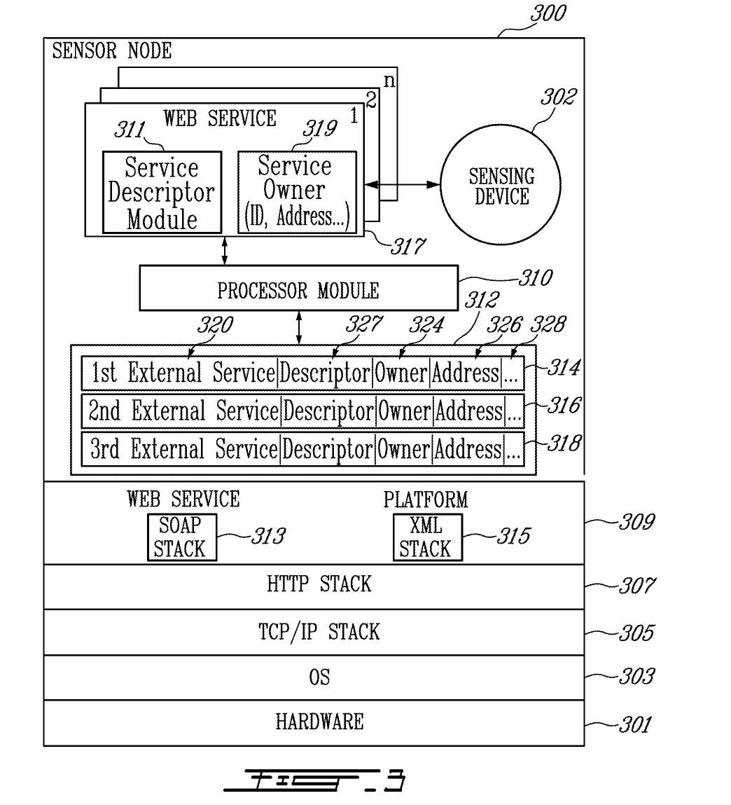

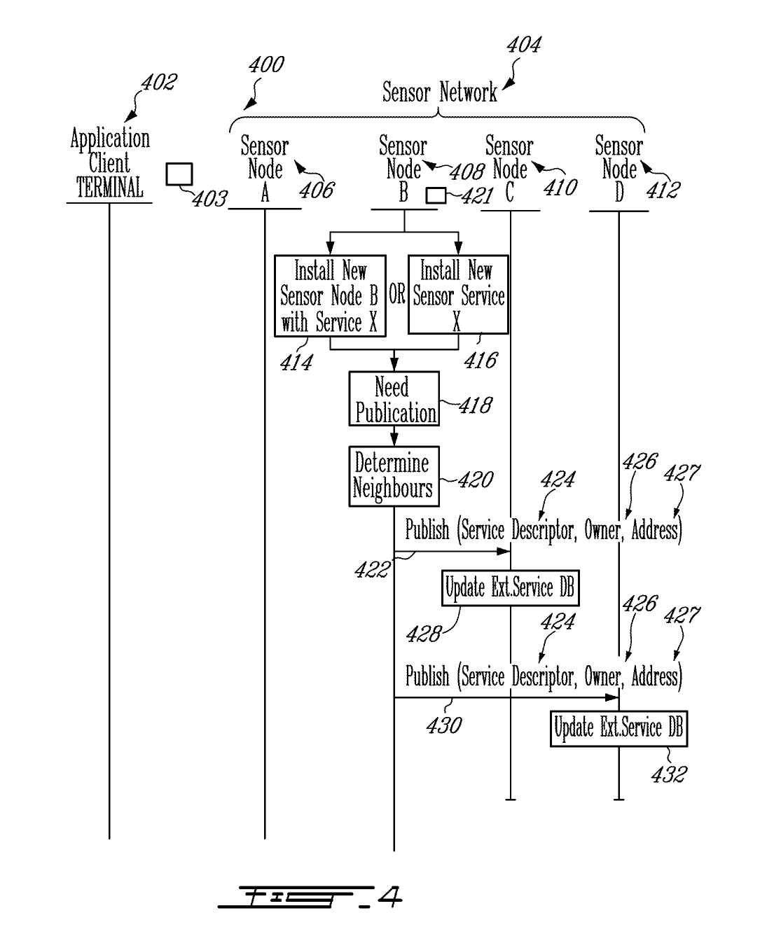

### DETAILED DESCRIPTION

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention takes advantage of the sink-less sensor network architecture to provide flexible access to sensor services. In one variant of the preferred embodiment of the invention, web services are used for accessing sensor data. A web service is a modular program module that can be discovered and invoked across the network. Web services are attractive to application developers as they provide a high level of abstraction, loose coupling and support for both synchronous and asynchronous communication. The proposed sink-less architecture for a sensor network preferably has neither sinks nor gateways and therefore allows a direct access of end-user applications to the sensed data from the sensors network. This means application devices can interact directly with the sensor nodes without going through a gateway. According to the invention, a sensor node is provided with information not only associated with the types of sensor service(s) provided locally by that sensor node but also with information associated to other sensor services provided by collaborating, neighbouring sensor nodes, so that when a request for a given type of sensed data is received by the sensor node, the later can either provide sensed data related to its own sensor services provide locally, if any, or otherwise can for example contact or refer to neighbouring sensor nodes that are identified as being responsible for the provision of the requested sensed data. Thus, the present invention allows a flexible approach for contacting sensor nodes, by removing the burden of knowing the exact address or identification of the sensor node providing the sensor service of interest. The invention therefore may allow other sensor nodes to be contacted in order to obtain information related to the desired sensor service.

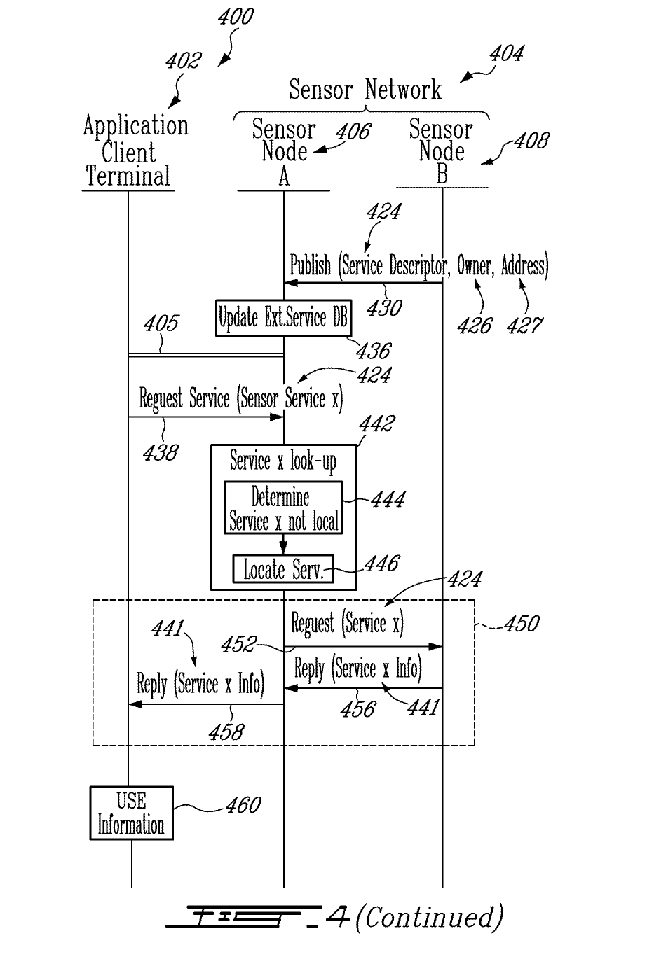

Reference is now made to FIG. 3, which is an exemplary high-level node diagram of a sensor node 300 according to the preferred embodiment of the present invention. According to the invention, the sensor node 300 comprises sensor hardware 301 necessary to run an operating system or platform 303 that supports, preferably, a TCP/IP (Transfer Control protocol/Internet Protocol) stack 305 and optionally an HTTP (Hyper Text Transfer Protocol) stack 307 for allowing the sensor node to exchange HTTP messages with other nodes. The sensor node 300 further includes a web service platform 309 that allows the sensor node to interact with any applications that support web services, and for this purpose may comprise a SOAP (Simple Object Access Protocol) stack 313 and an XML (Extensible Markup Language) stack 315 responsible for the interpretation and issuance of SOAP messages carrying XML payloads received, and respectively sent by the sensor node. For example, sensor data can be exchanged using an XML payload carried in a SOAP message, which s itself embodied in an HTTP message. The sensor node's function is to sense phenomena of interest via a one or more sensing devices 302 and to send the sensed data to requestors, such as for example to other sensor nodes or end-user applications. According to the invention, the phenomena of interest is sensed via the sensing device 302 and then relayed to a web service module 317. The web service module 317 is an application module responsible for managing the sensor service provided by the sensor node 300 and related to the sensing device 302. It comprises a descriptor module 311 including the description of the sensor service provided by the sensor node. For example, if the sensing device 302 functions to monitor temperature in the near environment, then the service description module 311 comprises the description of the service to sense temperature in the given region, such as for example “temperature in downtown Montreal”. The web service 317 further comprises a service owner description 319 identifying the owner of the service of monitoring temperature, such as for example the identity of a telecommunication operator Rogers. According to the preferred embodiment of the invention, the sensor node 300 not only comprises a description of services provided by itself, e.g. 311 as described, but also a data storage module 312, such as for example a memory or database, comprising description of external sensor services provided by other sensor nodes (not shown in FIG. 3) in near vicinity to the sensor node 300. Therefore, the data storage module 312 comprises information including the identification 320 of an external sensor service, a descriptor 322 of the sensor that may further describe the sensor service (e.g. “temperature in Montreal-North”), the owner 324 of the external service 320 (e.g. “Vodafone”), the address 326 of the sensor node (e.g. the IP address or an URL uniform resource locator) where the external service 320 can be found, and optionally other parameters 328 related to the service 320. The data storage module 312 may comprises one or more external services 320ᵢ described in database records 314, 316, and 318. The purpose for the sensor node 300 to comprise database records 314, 316, and 318 referring to external sensor services, is that when an end-user application contacts the sensors node 300 and requests access to a sensor service that is not provided by the sensor node 300 itself, the later may look up in its internal data storage module 312 in order to locate where and how the requested external service can be provided, and return the answer to the application client requester. For this purpose, the sensor node 300 also comprises a processor module 310 that processes requests for sensor services. In the instance where the sensor node 300 receives a request for a local sensor service (e.g. the sensor service identified by 311), such as for example for the temperature in downtown Montreal, the processor module 310 detects that this is a local service as per the description 311, and responds back to the requestor with the temperature sensed by the device 302. Alternatively, if the request received by the sensor node 300 is for an external service, such as for example for the external service identified at 314 i.e. the temperature in Montreal-North, the processing module 310 detects that that service is not internal, but it is rather provided by a different sensor node which address can be retrieved from the record 316. Then, in a first variant of the invention, the sensor node 300 returns the address of the proper sensor node to the requester so that the later can contact the sensor node providing the temperature in Montreal-North. Alternatively, according to a second variant of the invention, the sensor node 300 attempts itself to contact the sensor node that provides of the requested service in order to retrieve the requested sensed data and return that data to the requestor.

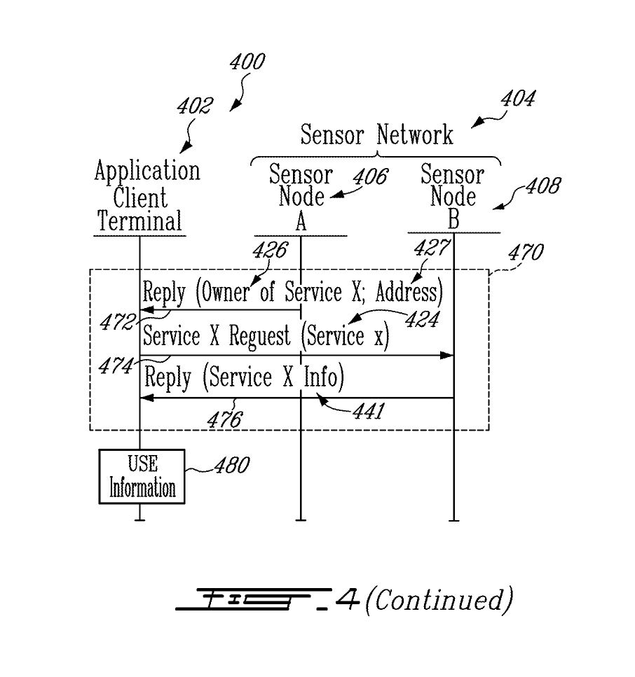

Reference is now made to FIG. 4, which shows an exemplary nodal operation and signal flow diagram of the preferred embodiment of the invention. Shown in FIG. 4 are, first, an application client terminal 402, and a network of sensors 404 that comprises a plurality of sensor nodes 406, 408, 410, and 412. The sensor network 404 can be for example a Wireless Sensor Network (WSN), where the sensor nodes shown are neighbour sensor nodes, i.e. at least some of them can communicate with each other using, for example, short range radio access technology, such as for example Bluetooth, Wi-Fi connections, or Zigbee short range radio connections. The sensor nodes 406-412 are alike the sensor node 300 described in relation to FIG. 3 and are assumed to be located in relative close proximity to each other, thus representing a given region of interest (e.g. same area, same town, same building, etc). The method described in FIG. 4 starts when the sensor node B 408 is installed in the network 404 with a new sensor service X, action 414, or when the new sensor service X is installed on the already existing sensor node B 408, action 416. In action 418, the sensor node B 408 detects the need to publish the new availability of the sensor service X so that chances to locate that new service by possible requesters are enhanced. In action 420, the sensor node B 408 determines the addresses to which the service X publication should be performed. Action 420 may include retrieving from a neighbour list 421 of the sensor node B 408 the identity of the neighbouring sensor nodes 406, 410 and 412. Then, in actions 422, 430 and 434 the neighbouring sensor nodes are transmitted information regarding the sensor service X using, for example, web service publish messages that comprise a sensor service X descriptor 424 describing the type of the service X, the identification of the owner 426 of the sensor service X, and the address 427 of the sensor node B 408 where the service X can be located. Each sensor node that receives the publish message updates its own database of external sensor services in actions 428, 432 and 436 respectively with the received information related to the sensor service X. At this point, each one of the sensor nodes 406, 410, and 412 have information related to sensor service X, including its service description and sensor node address, so that it can successfully handle a request for that service, in a manner that will now be described.

At a later point in time, a requester such as the application client terminal 402 may request sensed data related to the sensor service X. The user of the application client terminal 402 may use an application 403, such as for example a sensor application browser, in order to request sensed data related to service X. It is assumed that the application client terminal 402 is located closest to sensor node A 406, and thus a radio connection 405 is established via short range radio access between the node 406 and the application client terminal 402 (alternatively, sensor node A 406 may have been designated as the entry point for sensed data on behalf of a plurality of sensor nodes, e.g. sensor nodes 406-412). Then, the application client terminal 402 requests sensed data related to the service X by sending to the sensor node A 406 a sensor service request message 438 that identifies the requested sensor service X 424.

Upon receipt of the sensor service request message 438, the sensor node A 406 performs a lookup 442 in its local sensor service descriptors as well as in its external sensor service database for locating the service X. Part of action 442 can be to determine by a processor module of the sensor node 406 (action 444) that the service X is not a local sensor service and then locating the service X as being a sensor service external to the sensor node X 406, i.e. provided by another sensor node, which in the present case is identified to be sensor node B 408 (action 446).

Then, according to a first variant of the preferred embodiment of the invention, in action 450, the sensor node A 406 then requests the sensed data associated with the service X from the sensor node B 408 which has been found to be the sensor node providing the service X 424. Specifically, in action 452, the sensor network A 406 sends a request message to sensor node B 408 identifying the requested sensor service X 424 for requesting sensed data related to the sensor service X. The sensor node B 408 returns the requested sensed data 441 in a reply message 456 sent to the requested sensor node A 406. Sensor node A 406 can then relay the sensed data 441 to the requesting application client terminal 402 so that the later can use that data, action 460.

Alternatively, in action 470, there is shown a second variant of the preferred embodiment of the invention. That second variant shows a different manner of responding to the sensor service request 438 received by the sensor node A 406 from the application client terminal 402. Once the sensor node A 406 locates the service X in action 446, the sensor node A 406 replies back to the application terminal 402 in action 472 with information that identifies the sensor node that supports the requested sensor service. For example, that information may include the identification of the owner 426 of service X and the address 427 of the service node that provides the service X, which in the present case is the address of the sensor node B 408. Using the address 427, the application client terminal 402 sends a sensor service X request to sensor node B 408 in action 474, and obtains back in action 476, via a reply message, the service X sensed data 441, so that in action 480 it can use that information.

Therefore, it becomes apparent, that according to the present invention a sensor node is provided with information not only associated with the types of sensor services provided locally by that sensor node but also with information associated to sensor services provided by collaborating, neighbouring sensor nodes, so that when a sensor data request is received by the sensor node it can either provide the sensor service provide locally, if any, or otherwise can refer to neighbouring sensor nodes that are responsible for the provision of the requested services.

Based upon the foregoing, it should now be apparent to those of ordinary skills in the art that the present invention provides an advantageous solution, which offers a simple yet flexible and efficient manner of obtaining sensed data from sensor nodes. Although the system and method of the present invention have been described with particular reference to certain type of messages and nodes, it should be realized upon reference hereto that the innovative teachings contained herein are not necessarily limited thereto and may be implemented advantageously in various manners. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

1. A method for handling a sensor service request received at a sensor node of a sensor network, the method comprising the steps of:
a. receiving at the sensor node a request for a given sensor service from a requester;
b. determining that the sensor node does not support the given sensor service; and
c. identifying another sensor node of the sensor network that supports the given sensor service.

2. The method claimed in claim 1, further comprising, prior to step a., the step of:
d. the sensor node receiving information related to the given sensor service published by the other sensor node; and
e. the sensor node storing the information related to the given sensor service.

3. The method claimed in claim 2, wherein step d. includes receiving a publish message, the message including a service descriptor of the given sensor service and an address of the other sensor node that supports the given sensor service.

4. The method of claim 1, further comprising the step of:
d. responsive to the request for the given sensor service, returning from the sensor node to the requester a message comprising an identification of the other sensor node that supports the requested sensor service, whereby the requester uses the identification of the other sensor node to request the given sensor service from the other sensor node.

5. The method of claim 1, further comprising the step of:
d. responsive step c., requesting from the other sensor node that supports the given sensor service, sensed data related to the given sensor service; and
e. receiving the sensed data from the other sensor node; and
f. transmitting the sensed data to the requester of the given sensor service.

6. A sensor node comprising:
a description of a sensor service provided by the sensor node;
a data storage module comprising information related to another sensor service provided by another sensor node, the information including a description of the other sensor service and an address of the other sensor node; and
a processing module that upon receipt at the sensor node of a request for the other sensor service from a requester, determines that the sensor node does not support the other sensor service and identifies the other sensor node that supports the other sensor service.

7. The sensor node claimed in claim 6, the sensor node receiving prior to the receipt of the request for the other sensor service from a requester, information published by the other sensor node and related to the other sensor service, and storing the information in the data storage module.

8. The sensor node claimed in claim 7, the information is received via a publish message, and includes a service descriptor of the other sensor service and an address of the other sensor node.

9. The sensor node of claim 6, wherein responsive to the request for the given sensor service, the sensor node returns to the requester a message comprising an identification of the other sensor node that supports the other sensor service, whereby the requester uses the identification of the other sensor node to request the given sensor service from the other sensor node.

10. The sensor node of claim 6, wherein responsive to the request for the given sensor service, the sensor node requests from the other sensor node that supports the given sensor service sensed data related to the given sensor service; and upon receipt of the sensed data from the other sensor node, transmits the sensed data to the requester.

11. The sensor node of claim 6, further comprising:
a web service module comprising the description of the sensor service provided by the sensor node.

12. A sensor network comprising a first and a second sensor nodes, wherein each one of the first and second sensor nodes comprises:
a description of a sensor service and an identification of an owner of the sensor service supported by that sensor node; and
information related to another sensor service, the information comprising a description of the other sensor service supported by another sensor node, and an address of the other sensor node.

13. The sensor network of claim 12, wherein the first and second sensor nodes communicate with each other using a short range radio connection.

14. The sensor network of claim 13, wherein the sensor network is a Wireless Sensor Network (WSN).
